(19) United States
(12) Patent Application Publication
(10) Pub. No.: US 2005/0260030 A1
(43) Pub. Date: Nov. 24, 2005

(54) D-ring binder mechanism with complementary ring tips

(75) Inventor: Yiu Wing Wong, Ma On Shan (HK)

Correspondence Address: SHOEMAKER AND MATTARE, LTD, 10 POST OFFICE ROAD - SUITE 110, SILVER SPRING, MD, 20910, US

(73) Assignee: Hong Kong Stationery Manufacturing Co., Ltd., Kowloon (HK)

(21) Appl. No.: 10/849,546

(22) Filed: May 20, 2004

(51) Int. Cl. B42F 13/00

(52) U.S. Cl. 402/54

(57) ABSTRACT

A D-ring binder mechanism has a number of rings of either the slanted or non-slanted type. Each ring has a rectilinear part. The other part has an arcuate shape, and has a recess in its tip. A protrusion at the tip of the rectilinear part seats in the recess A lateral window in the recessed tip, intersecting the recess, enables the protrusion to seat smoothly in the recessed tip notwithstanding the fact that the relative motion between the approaching tips has a large lateral component.

### BACKGROUND OF THE INVENTION

This invention relates to a D-ring binder mechanism, for a loose-leaf ring binder, in which one half of each ring terminates in a straight segment.

A typical looseleaf binder has a ring binder mechanism which holds at least two paper-retaining rings and toggles between open and closed positions. The toggling action is produced by a pair of hinged plates held in edgewise compression between the corners of a flexible arched housing. The rings are formed in mating parts attached to respective ones of the plates. The rings then snap open or shut when enough force is applied to the rings, either directly, or by devices such as levers or triggers at the two ends of the housing.

In most ring binders, the opposed ring parts are both semicircular, so that when they are closed, they form substantially a circular shape. One problem with semicircular ring parts is that they do not make it easy to load or remove large numbers of papers at once onto or off of the rings. Automatic machine loading of papers onto such rings is particularly difficult. For this reason, some prior inventors have developed rings in which one segment is straight, or almost so. With such rings, commonly called D-rings, a large group of papers can be lowered right onto the straight segments very simply and quickly. But since D-rings are not symmetrical, and the tips meet to the left or right of the center plane of the housing, they approach one another not axially, but rather with a lateral component. The greater the offset, the greater the lateral component. When one tip is designed to seat within in recess in the other, a lateral approach may result in interference between the approaching tips, preventing or impeding proper seating. The solution to this problem, until now, has been to bend the tip of the straight segment inward toward the arcuate segment. That solution, however, works against the goal of facilitating the installation and removal of large groups of papers.

### SUMMARY OF THE INVENTION

An object of the invention is to provide a ring binder mechanism having D-shaped rings of either the slanted type on non-slanted type, having a perfectly straight segment onto which large groups of papers can be easily loaded and removed.

A related object is to provide a ring tip geometry which permits the tips to approach one another at a substantial angle to their length, and to seat smoothly and without interference.

These and other objects are attained by a D-ring binder mechanism as described below.

### BRIEF DESCRIPTION OF THE DRAWINGS

In the accompanying drawings:

FIG. 1 is an isometric view of a D-ring binder mechanism having slanted rings, embodying the invention, showing the rings closed;

FIG. 2 is a view like FIG. 1, showing the rings open;

FIG. 3 is a view like FIG. 1, showing the rings slightly ajar;

FIG. 4 is a view like FIG. 2, showing an alternative form of the invention; and

FIG. 5 is a view like FIG. 3, showing a second alternative form of the invention.

### DESCRIPTION OF THE PREFERRED EMBODIMENT

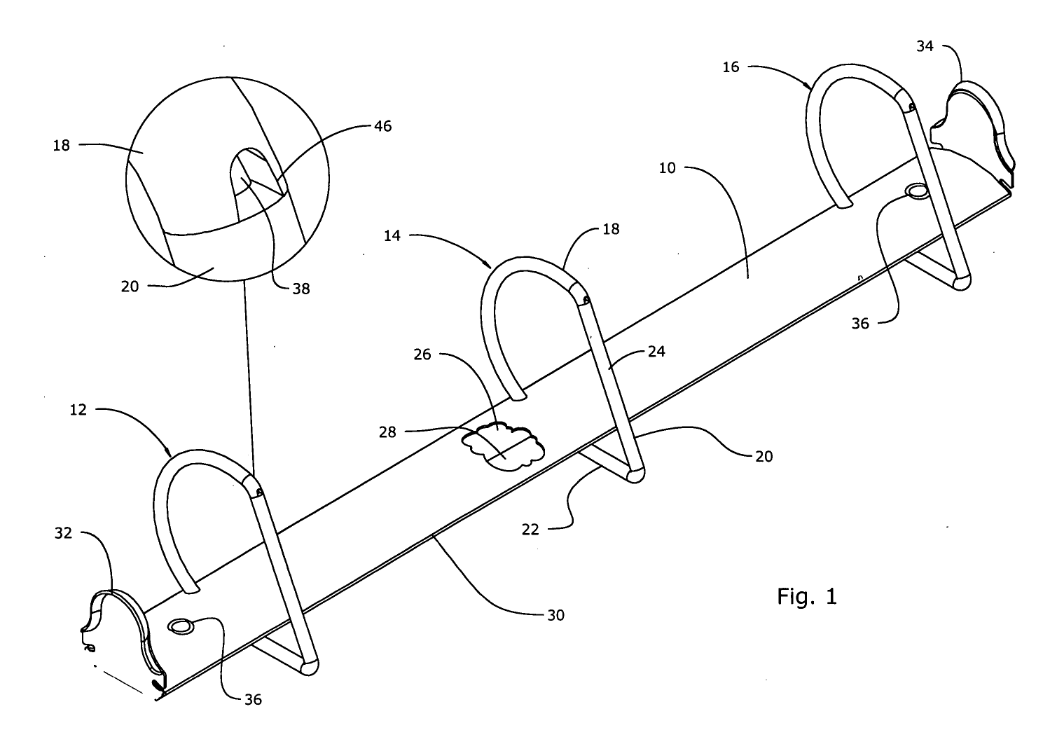

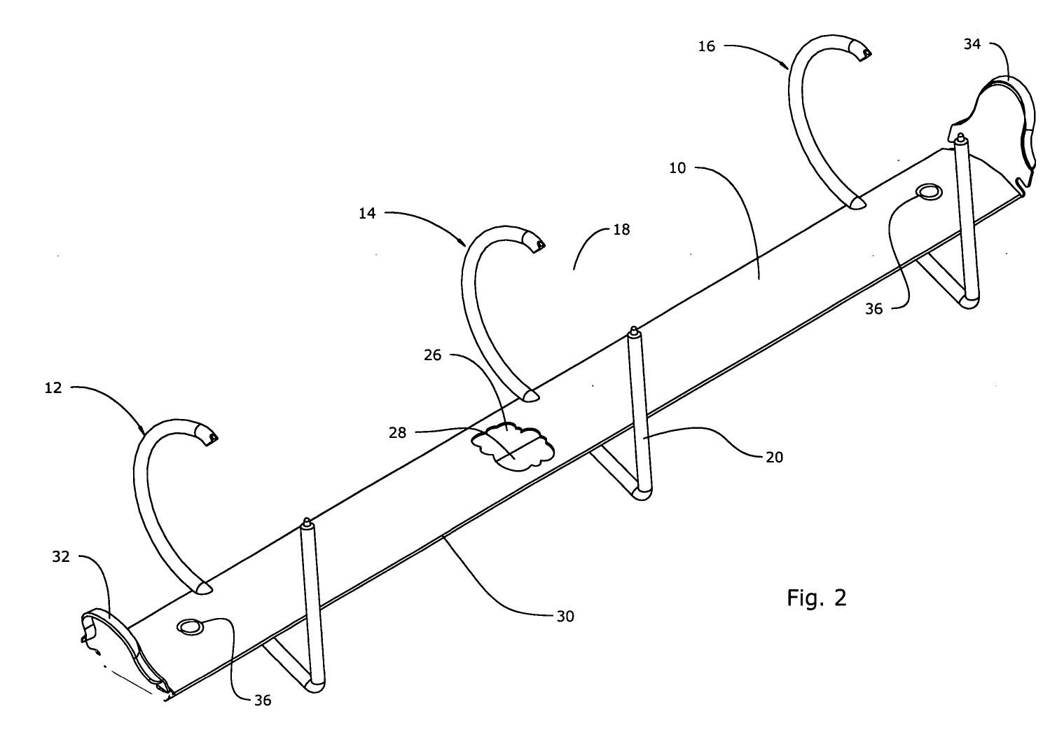

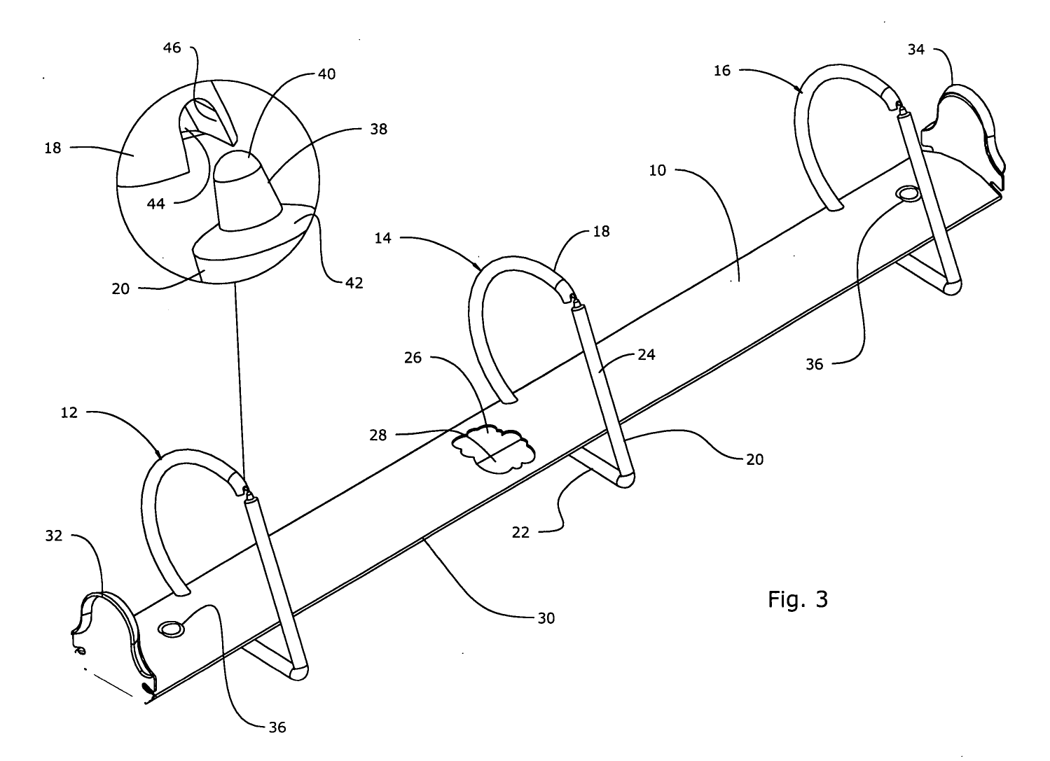

A D-ring binder mechanism embodying the invention is shown in FIGS. 1-3. As with all common ring binders, the mechanism includes a housing 10 made of resilient sheet metal, preferably steel. Three two-part rings 12, 14, 16 extend from the housing at equal intervals. Each ring has a substantially arcuate part 18 and a rectilinear part 20. The rectilinear part comprises a substantially horizontal proximal segment 22 and a straight distal segment 24 which extends upward from the proximal segment, at an angle of about 60° to 80° to the base plane of the housing, depending on the ring geometry. The ring parts 18, 20 are affixed at their bottom ends to respective hinged plates 26, 28 whose outer edges are seated in the lateral edges 30 of the housing, which lie in the base plane. The plates cause the ring parts to move in unison. Their inner edges, which are held together by small tabs (not shown) can move upward and downward within the confines of the housing. When the rings are closed (FIG. 1), the plates are in their lowermost position, and when the rings are open (FIG. 2), the plates are in their uppermost position. Because of the inward force applied to the edges of the plates by flexure of the housing, only the fully open and fully closed positions are stable. When the parts are at any intermediate position, such as FIG. 3, the compression forces on the plates tends to snap the rings apart or together. FIG. 3 is therefore a transient position, and is presented only to show how the tips of the rings approach the fully nested position of FIG. 1.

The levers 32, 34 at the ends of the mechanism, which engage the plates 26, 28 from below, can be manipulated to open or close the rings. Alternatively, one can grasp the ring segments directly to open and close them.

The rivets 36 hold the mechanism to a binder spine. Details of the connection are not pertinent to this invention.

The insets in FIGS. 1 and 3 show the ring tips, greatly enlarged. The tip of the rectilinear part 20 has a protrusion 38 which includes a short part of a diameter substantially less than that of the ring cross-section. The protrusion has been shown rounded at the top 40, and with a conical base part 42, but these details are only preferred. Whatever the exact shape of the protrusion, the tip of the curved part 18 of the ring has a complementary recess 44 for receiving the protrusion 38. A window 46 is provided to permit the protrusion 38 to enter into the recess at an angle, since the tips do not approach one another lengthwise, but rather more laterally. The window may have various shapes, but in any event it should be at least as large as the cross-section of the protrusion 38, so that the protrusion can enter the recess without interference. The window may be made somewhat larger than that, to account for tolerances and bending of the components; however, too large a window would result in a less secure union between the mating tips.

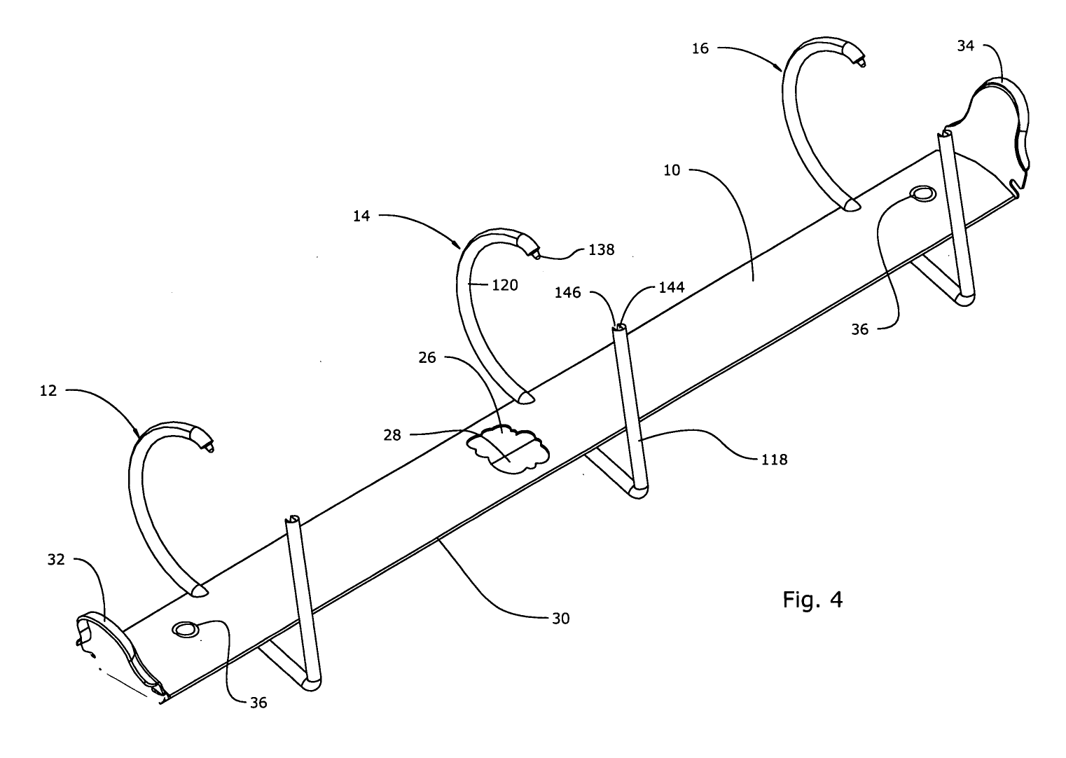

While the protrusion has been described and shown on the rectilinear segment, with the complementary recess on the arcuate segment, it is possible to reverse the arrangement. FIG. 4 shows this modification: the rectilinear part 118 of the ring has a recess 144 in its tip, and the curved part 120 has a protrusion 138 adapted to seat in the recess. Note that the window 146 intersecting the recess is on the opposite side of the tip, facing the center plane of the binder. The idea is the same—to permit the protrusion to land smoothly in the recessed tip without interference;

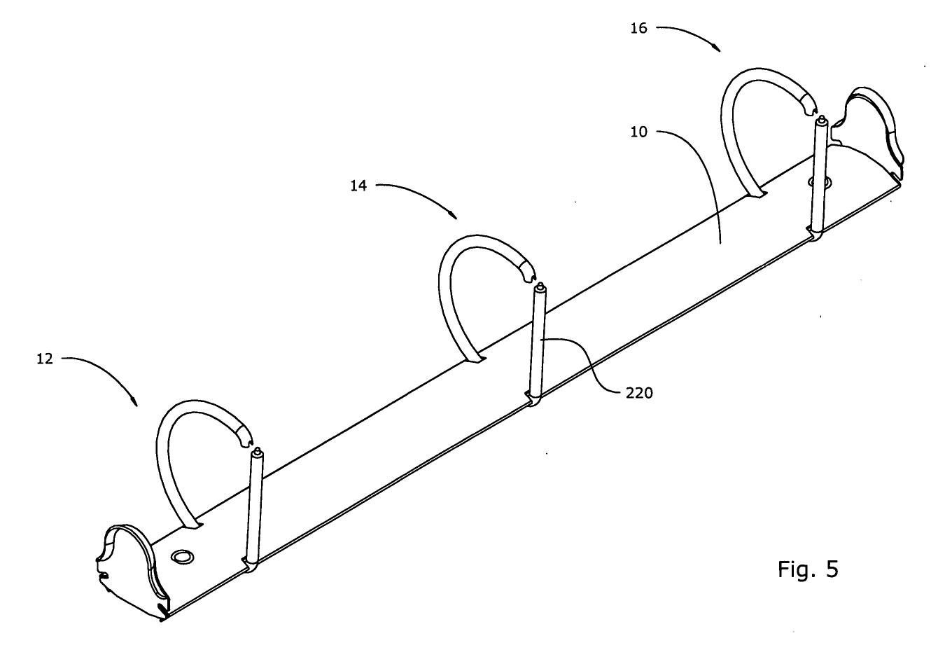

In another modification (FIG. 5), the invention is applied to a D-ring binder having non-slanted rings. Here, the straight segment 220 of the rectilinear part is perpendicular to the base plane in which the lateral edges of the housing lie, so papers can be lowered straight down over the segment.

Since the invention is subject to modifications and variations, it is intended that the foregoing description and the accompanying drawings shall be interpreted as only illustrative of the invention defined by the following claims.

1. In a ring binder mechanism comprising a housing containing a pair of hinged plates and a plurality of rings, each ring comprising two parts, each part being connected to a respective one of said plates so that the rings can be opened and closed as the plates pivot within the housing, the improvement wherein
one of the parts is substantially arcuate terminating at a first tip and the other of said parts has a straight segment terminating at a second tip, one of said tips having a protrusion and the other of said tips having a complementary recess for receiving the protrusion when the rings are closed.

2. The invention of claim 1, wherein the tip with the complementary recess also has a lateral window intersecting the recess, the window being shaped to permit the protrusion to enter the recess from a substantially lateral direction.

3. The invention of claim 1, wherein the housing has lateral edges lying in a common base plane, and said straight segment extends substantially perpendicular to the base plane when the rings are closed.

4. The invention of claim 1, wherein the housing has lateral edges lying in a common base plane, and said straight segment is slanted and extends substantially oblique to the base plane when the rings are closed.
